(19) United States
(12) Patent Application Publication
(10) Pub. No.: US 2016/0170553 A1
(43) Pub. Date: Jun. 16, 2016

(54) INFORMATION PROCESSING APPARATUS AND CONTROL METHOD FOR INFORMATION PROCESSING APPARATUS

(71) Applicant: FUJITSU LIMITED, Kawasaki-shi (JP)

(72) Inventors: Takahiro Hatanaka, Inagi (JP); Kenshi Takamoto, Inagi (JP); Yuji Takemoto, Kawasaki (JP)

(21) Appl. No.: 14/880,745

(22) Filed: Oct. 12, 2015

(30) Foreign Application Priority Data
Dec. 12, 2014 (JP) 2014-251531

(51) Int. Cl. G06F 3/041; G06K 9/00; G06F 1/32

(52) U.S. Cl. CPC G06F 3/0416; G06F 1/3265; G06F 1/3218; G06F 3/0412; G06K 9/0002

(57) ABSTRACT

An information processing apparatus includes a sensor; a touch panel; and a processor coupled to the sensor and the touch panel and is configured to control the information processing apparatus, wherein the sensor is configured to transmit an interrupt notification to the touch panel so as to wake up the touch panel when detecting an operation performed upon the sensor, and wherein the touch panel is configured to: determine whether a contact with the touch panel has been detected when being waked up, and transmit an interrupt notification to the processor so as to wake up the processor when it is determined that a contact with the touch panel has not been detected.

### CROSS-REFERENCE TO RELATED APPLICATION

This application is based upon and claims the benefit of priority of the prior Japanese Patent Application No. 2014-251531, filed on Dec. 12, 2014, the entire contents of which are incorporated herein by reference.

### FIELD

The embodiments discussed herein are related to an information processing apparatus such as a mobile terminal apparatus and a control method for an information processing apparatus.

### BACKGROUND

In recent years, there has been a growing interest in information security. Information processing apparatuses such as mobile telephones or smart phones including a fingerprint sensor capable of identifying a user (user authentication) with the fingerprint of the user are widely used. It is difficult for a user to use such an information processing apparatus including a fingerprint sensor without being successfully authenticated. This reduces the leakage of information to a third party.

Some of information processing apparatuses including a fingerprint sensor use the fingerprint sensor not only for user authentication but also for their wake-up from a sleep mode. The sleep mode is a power saving mode in which the supply of power to a central processing unit (CPU) functioning as a main control unit in an information processing apparatus is stopped. In the sleep mode, a backlight for a display device in an information processing apparatus is turned off and a screen is turned off (no image is displayed on the screen). Wake-up is to bring a CPU back to a state before the sleep mode. After wake-up has been performed, the screen of a display device is turned on (an image is displayed on the screen). Examples of related art include Japanese Laid-open Patent Publication Nos. 2002-351444, 2002-207525, and 2012-221435.

In a case where a user carries an information processing apparatus including a fingerprint sensor having a function of waking up the information processing apparatus, the information processing apparatus may be waked up when the user unintentionally touches the fingerprint sensor. For example, when the user carelessly picks up the information processing apparatus or has the information processing apparatus in a pocket, a part of the hand of the user, for example, a finger of the user, may touch the fingerprint sensor. At that time, it is difficult for the fingerprint sensor to determine whether it has been intentionally touched by the user. Accordingly, the fingerprint sensor wakes up the information processing apparatus when detecting the contact with the fingerprint sensor.

When the information processing apparatus is waked up, the supply of power to a CPU is restarted and a display device is activated as described previously. At that time, power is consumed. The amount of power consumption of the CPU and the display device is larger than that of the other components in the information processing apparatus. From the viewpoint of power saving, it is desirable that the occurrence of unnecessary wake-up be reduced.

### SUMMARY

According to an aspect of the invention, an information processing apparatus includes a sensor; a touch panel; and a processor coupled to the sensor and the touch panel and is configured to control the information processing apparatus, wherein the sensor is configured to transmit an interrupt notification to the touch panel so as to wake up the touch panel when detecting an operation performed upon the sensor, and wherein the touch panel is configured to: determine whether a contact with the touch panel has been detected when being waked up, and transmit an interrupt notification to the processor so as to wake up the processor when it is determined that a contact with the touch panel has not been detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exemplary functional block diagram of a mobile terminal apparatus according to a first embodiment of the present disclosure;

FIG. 2 is a diagram illustrating an exemplary hardware configuration of a mobile terminal apparatus according to the first embodiment;

FIG. 3 is an exemplary top view of a mobile terminal apparatus according to the first embodiment;

FIG. 4 is a diagram illustrating the contact of a user's hand with a fingerprint sensor in a mobile terminal apparatus;

FIG. 5 is another exemplary top view of a mobile terminal apparatus;

FIGS. 6A and 6B are other exemplary top views of a mobile terminal apparatus;

FIG. 7 is a flowchart illustrating an exemplary information processing method performed by a mobile terminal apparatus according to the first embodiment;

FIG. 8 is a flowchart illustrating a modification of an information processing method performed by a mobile terminal apparatus according to the first embodiment;

FIG. 9 is an exemplary functional block diagram of a mobile terminal apparatus according to a second embodiment of the present disclosure;

FIG. 10 is a flowchart illustrating an exemplary information processing method performed by a mobile terminal apparatus according to the second embodiment;

FIG. 11 is an exemplary functional block diagram of a mobile terminal apparatus according to a third embodiment of the present disclosure;

FIG. 12 is a diagram illustrating an exemplary hardware configuration of a mobile terminal apparatus according to the third embodiment; and

FIG. 13 is a flowchart illustrating an exemplary information processing method performed by a mobile terminal apparatus according to the third embodiment.

### DESCRIPTION OF EMBODIMENTS

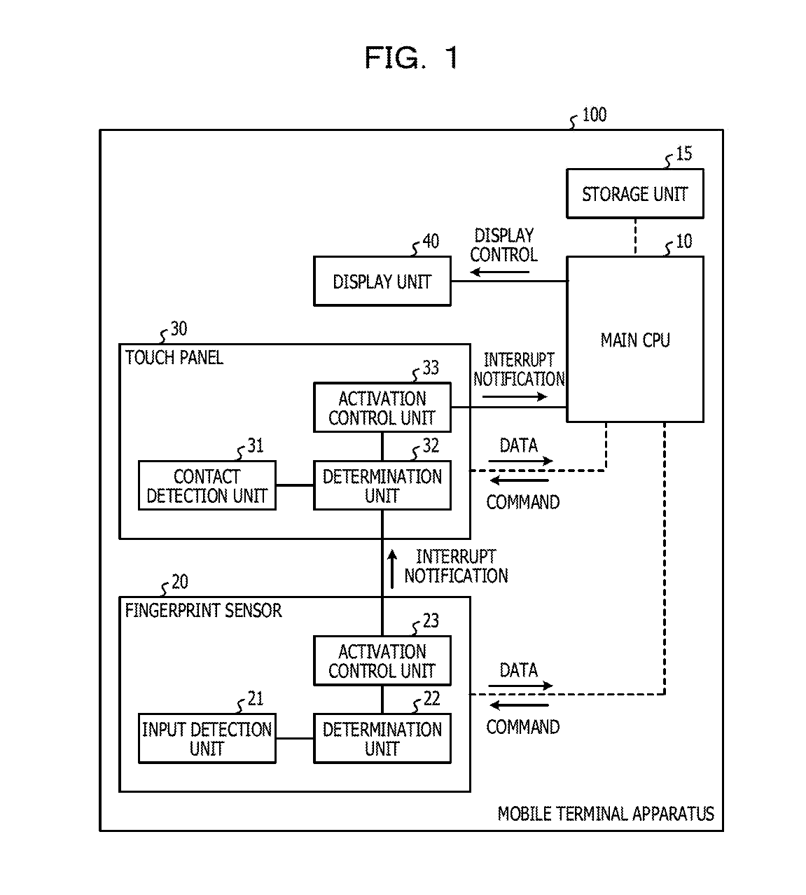

Embodiments of the present disclosure will be described in detail below with reference to FIGS. 1 to 13.

In the following description, examples of an information processing apparatus according to an embodiment of the present disclosure include a mobile telephone and a tablet terminal. However, other examples of an information processing apparatus according to an embodiment of the present disclosure may be employed.

### First Embodiment

FIG. 1 is an exemplary functional block diagram of a mobile terminal apparatus according to the first embodiment. As illustrated in FIG. 1, a mobile terminal apparatus 100 includes a main CPU 10 that is a main control unit, a storage unit 15, a fingerprint sensor 20 that is an operation unit, a touch panel 30, and a display unit 40. The main CPU 10 is coupled to the storage unit 15, the fingerprint sensor 20, the touch panel 30, and the display unit 40 so that they can communicate with each other. For convenience of reference in FIG. 1, the connection between blocks according to the first embodiment is represented by a solid line and the other connections are represented by broken lines. The mobile terminal apparatus 100 is, for example, a smart phone, a mobile telephone, or a tablet terminal. In the following description, the recovery of the main CPU 10 or the touch panel 30 from a sleep state is also sometimes referred to as wake-up.

The main CPU 10 is a piece of hardware for managing processing in the mobile terminal apparatus 100, and may be achieved not only by a CPU but also by a micro processing unit (MPU). The main CPU 10 performs processing by transmitting a command to a peripheral component such as the fingerprint sensor 20 or the touch panel 30 and receiving data from the peripheral component. In a case where the mobile terminal apparatus 100 receives no operation input within a predetermined period, the main CPU 10 is brought into a sleep state for the sake of power saving. On the other hand, upon externally receiving an interrupt notification, the main CPU 10 performs wake-up and changes from the sleep state to a state in which a user can use the mobile terminal apparatus 100. The main CPU 10 is equivalent to an example of a control unit.

The storage unit 15 is a piece of hardware for storing data used for processing performed by the main CPU 10 and a program. The storage unit 15 may be achieved using a plurality of storage devices in accordance with an application or a desired storage capacity.

The fingerprint sensor 20 is an electronic component that a user uses for user authentication based on fingerprints. The fingerprint sensor 20 can transmit data used for user authentication, for example, biological information obtained from a fingerprint, to the main CPU 10. Furthermore, the fingerprint sensor 20 can cause the touch panel 30 to wake up (can perform an apparatus activation operation) by transmitting an interrupt notification. For example, the fingerprint sensor 20 is a sensor that causes the main CPU 10 to perform wake-up in response to the press of the fingerprint sensor 20 by a finger. Alternatively, for example, the fingerprint sensor 20 is a sensor that causes the main CPU 10 to perform wake-up without causing a user to perform a login when the user inputs biological information into the fingerprint sensor 20 by touching the surface (sensor surface) of an insulating film of the fingerprint sensor 20 with a finger and is successfully authenticated.

The fingerprint sensor 20 includes an input detection unit 21, a determination unit 22, and an activation control unit 23. The input detection unit 21 has a sensor surface and detects an operation input to the sensor surface. The operation input to the sensor surface is, for example, the contact of a finger or the like with the sensor surface or the press of a button on the sensor surface. The determination unit 22 determines whether the input detection unit 21 has detected an operation input to the sensor surface. The activation control unit 23 transmits an interrupt notification to the touch panel 30 so as to cause the touch panel 30 to perform wake-up when the input detection unit 21 detects an operation input to the sensor surface. The fingerprint sensor 20 is equivalent to an example of a sensor.

The touch panel 30 is an input device that allows a user to operate the mobile terminal apparatus 100 by touching the operation surface of the touch panel 30 with a finger. In order to detect the contact of a finger or the like, for example, the capacitive sensing method is used. The capacitive sensing method is a method of detecting the change in electrostatic capacitance caused by the contact of a finger or the like with the operation surface that overlaps a plurality of electrodes arranged in a lattice shape. Upon detecting the contact of a finger or the like with the operation surface, the touch panel 30 can specify coordinates at a contact position and transmits data on the specified coordinates to the main CPU 10.

The touch panel 30 includes a contact detection unit 31, a determination unit 32, and an activation control unit 33. The contact detection unit 31 has an operation surface and detects the contact of a finger or the like with the operation surface. The contact detection unit 31 notifies the determination unit 32 of the fact that the contact of a finger or the like has been detected. Upon receiving an interrupt notification from the activation control unit 23 in the fingerprint sensor 20, the determination unit 32 activates the touch panel 30. The determination unit 32 determines whether the touch panel 30 has been touched by a finger based on information received from the contact detection unit 31. In a case where the determination unit 32 determines that the touch panel 30 has not been touched by a finger, the activation control unit 33 allows the input of data into the main CPU 10. More specifically, the activation control unit 33 transmits an interrupt notification to the main CPU 10 so as to cause the main CPU 10 to perform wake-up. The activation control unit 33 is equivalent to an example of an instruction unit.

The display unit 40 is a device for displaying an image. The display unit 40 is achieved by, for example, a liquid crystal display, a plasma display, or an organic electroluminescent display. More specifically, a display device is provided by disposing the touch panel 30 on the display unit 40. By turning on the screen of the display unit 40, that is, by turning on a backlight, an image including the touch panel 30 can be displayed on the screen. The display unit 40 can switch between the ON and OFF states of the screen in accordance with a display control signal received from the main CPU 10.

Next, the hardware configuration of the mobile terminal apparatus 100 will be described.

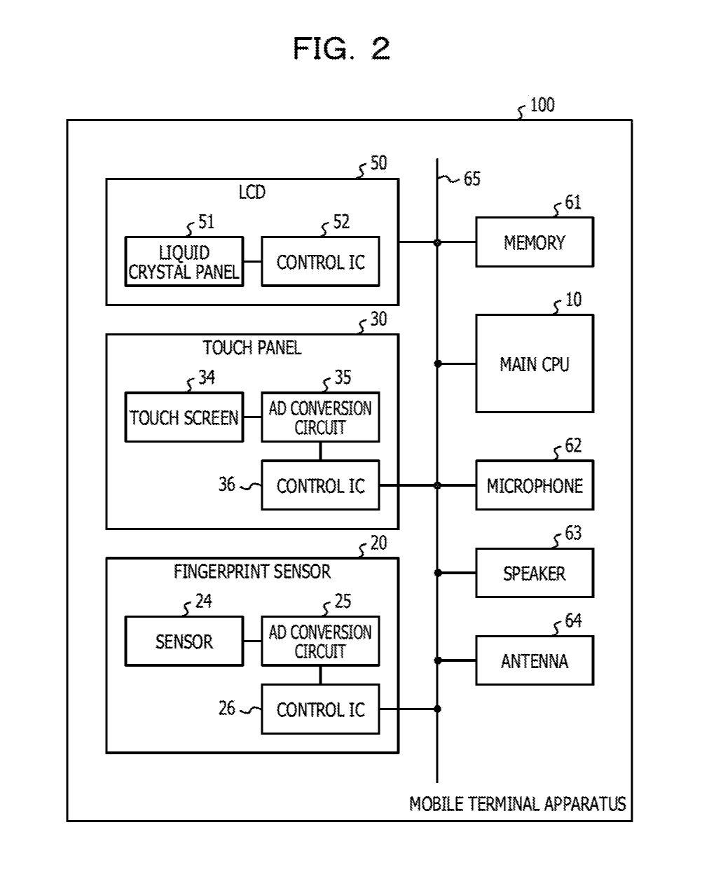

FIG. 2 is a diagram illustrating an exemplary hardware configuration of the mobile terminal apparatus 100 according to the first embodiment. As illustrated in FIG. 2, the mobile terminal apparatus 100 includes the fingerprint sensor 20, the touch panel 30, a liquid crystal display (LCD) 50, the main CPU 10, a memory 61, a microphone 62, a speaker 63, and an antenna 64. Each component in the mobile terminal apparatus 100 is coupled to a bus 65.

The fingerprint sensor 20 includes a sensor 24, an analog-to-digital (AD) conversion circuit 25, and a control integrated circuit (IC) 26. The sensor 24 acquires fingerprint information through a sensor surface. The AD conversion circuit 25 receives biological information about a fingerprint from the sensor 24, converts the biological information into digital data, and outputs the digital data to the control IC 26. The sensor 24 and the AD conversion circuit 25 are equivalent to an example of the input detection unit 21 illustrated in FIG. 1.

The control IC 26 is equivalent to examples of the determination unit 22 and the activation control unit 23 illustrated in FIG. 1. The control IC 26 includes a processor for executing various pieces of processing, a memory for storing a program used for the above-described notification processing, and a memory used as a register for temporarily storing data used for the notification processing. The control IC 26 is controlled by the main CPU 10 via the bus 65 and controls the sensor 24 and the AD conversion circuit 25. The control IC 26 can also be achieved by a CPU. The AD conversion circuit 25 can also be a part of the control IC 26.

The touch panel 30 includes a touch screen 34, an AD conversion circuit 35, and a control IC 36. The touch screen 34 is provided with a panel having an operation surface. The touch screen 34 detects the contact of a finger or the like with the operation surface and acquires information about coordinates at a point of the contact with the operation surface. The AD conversion circuit 35 converts the information about the contact point received from the touch screen 34 into digital data and outputs the digital data to the control IC 36. The touch screen 34 and the AD conversion circuit 35 are equivalent to an example of the contact detection unit 31 illustrated in FIG. 1.

The control IC 36 is equivalent to an example of the determination unit 32 illustrated in FIG. 1. The control IC 36 includes a processor for executing various pieces of processing, a memory for storing a program used for the above-described determination processing, and a memory used as a register for temporarily storing data used for the determination processing. The control IC 36 is controlled by the main CPU 10 via the bus 65 and controls the touch screen 34 and the AD conversion circuit 35. The control IC 36 can also be achieved by a CPU. The AD conversion circuit 35 can also be a part of the control IC 36.

The LCD 50 is equivalent to an example of the display unit 40 illustrated in FIG. 1, and is integrated with the touch panel 30. The LCD 50 is disposed under the touch panel 30 so that the LCD 50 and the touch panel 30 overlap with each other, and functions as a backlight. The LCD 50 includes a liquid crystal panel 51 and a control integrated circuit (IC) 52.

The liquid crystal panel 51 is the body of the LCD 50. The control IC 52 is an IC for controlling the operation of the liquid crystal panel 51. The control IC 52 may be integrated with the control IC 36. The control IC 52 can also be achieved by a CPU.

The memory 61 is equivalent to an example of the storage unit 15 illustrated in FIG. 1. The memory 61 is, for example, a Random Access Memory (RAM), a flash memory, or a Read-Only Memory (ROM), and may be the combination of some of them. For example, a RAM and a NAND flash memory can be used for the storage of data. On the other hand, a NOR flash memory and a ROM can be used for the storage of a program.

The microphone 62 is a component for receiving sound information. The speaker 63 is a component for outputting sound information. The antenna 64 is a component for receiving radio waves from an external apparatus or transmitting radio waves to an external apparatus.

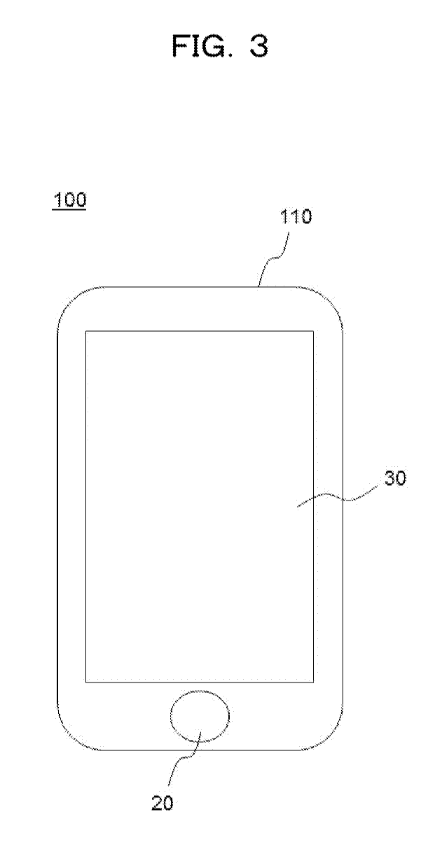

FIG. 3 is an exemplary top view of a mobile terminal apparatus. Referring to FIG. 3, the same reference numerals are used to identify parts already described with reference to FIG. 1. As illustrated in FIG. 3, the mobile terminal apparatus 100 includes a housing 110 and the fingerprint sensor 20 and the touch panel 30 which are arranged on the upper surface of the housing 110. By pressing a button on the upper surface of the fingerprint sensor 20, the mobile terminal apparatus 100 can be waked up. Alternatively, instead of by pressing a button on the upper surface of the fingerprint sensor 20, only by touching the fingerprint sensor 20, the mobile terminal apparatus 100 may be waked up.

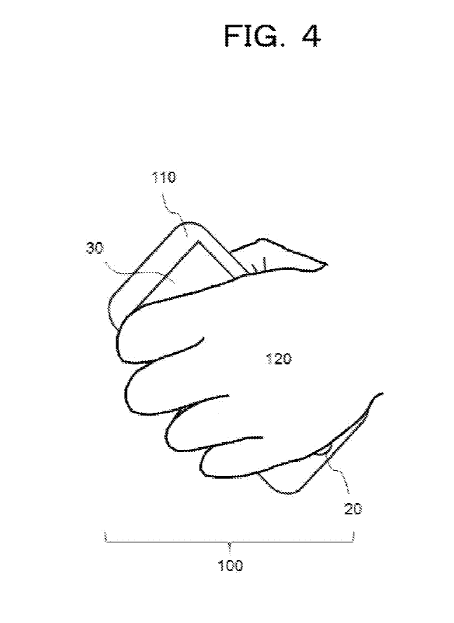

FIG. 4 is a diagram illustrating the contact of a user's hand with a fingerprint sensor in a mobile terminal apparatus. Referring to FIG. 4, the fingerprint sensor 20 is disposed next to the touch panel 30 in the mobile terminal apparatus 100. As illustrated in FIG. 4, in a case where a user holds the mobile terminal apparatus 100 with one hand, a user's hand 120 sometimes touch both the fingerprint sensor 20 and the touch panel 30 at the same time.

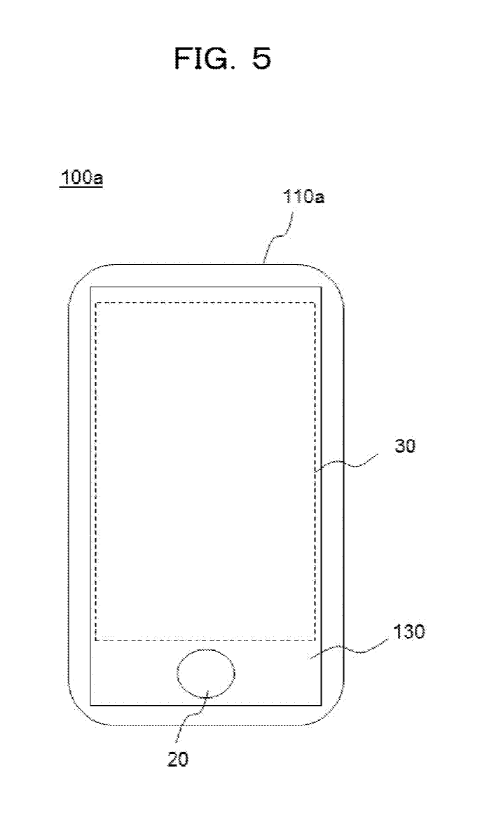

FIG. 5 is another exemplary top view of a mobile terminal apparatus. Referring to FIG. 5, the same reference numerals are used to identify parts already described with reference to FIG. 1. As illustrated in FIG. 5, a mobile terminal apparatus 100a includes a housing 110a and the fingerprint sensor 20 and the touch panel 30 which are arranged on the upper surface of the housing 110a. The mobile terminal apparatus 100a further includes a cover glass 130 covering the upper surfaces of the fingerprint sensor 20 and the touch panel 30. When a finger is placed at a position on the cover glass 130 corresponding to the fingerprint sensor 20, the contact of the finger is detected and the mobile terminal apparatus 100a is waked up.

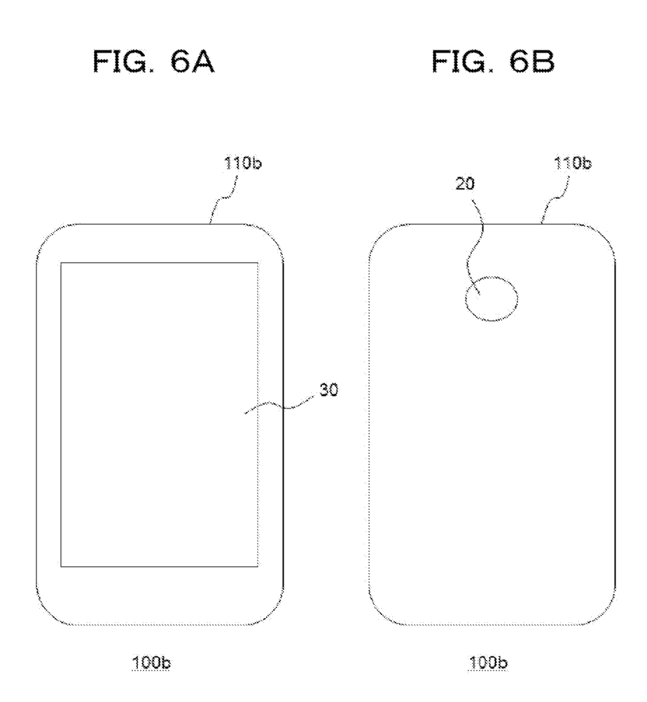

FIGS. 6A and 6B are other exemplary top views of a mobile terminal apparatus. FIG. 6A illustrates the upper surface of a mobile terminal apparatus 100b. FIG. 6B illustrates the undersurface of the mobile terminal apparatus 100b. As illustrated in FIG. 6A, on the upper surface of the mobile terminal apparatus 100b, the touch panel 30 is disposed. As illustrated in FIG. 6B, on the undersurface of the mobile terminal apparatus 100b, the fingerprint sensor 20 is disposed. Like the mobile terminal apparatus 100 illustrated in FIG. 3, the mobile terminal apparatus 100b can be waked up by pressing a button on the upper surface of the fingerprint sensor 20 with a finger in a sleep state. Alternatively, like the mobile terminal apparatus 100 illustrated in FIG. 3, the mobile terminal apparatus 100b may be waked up only by touching the fingerprint sensor 20 with a finger instead of by pressing a button on the upper surface of the fingerprint sensor 20.

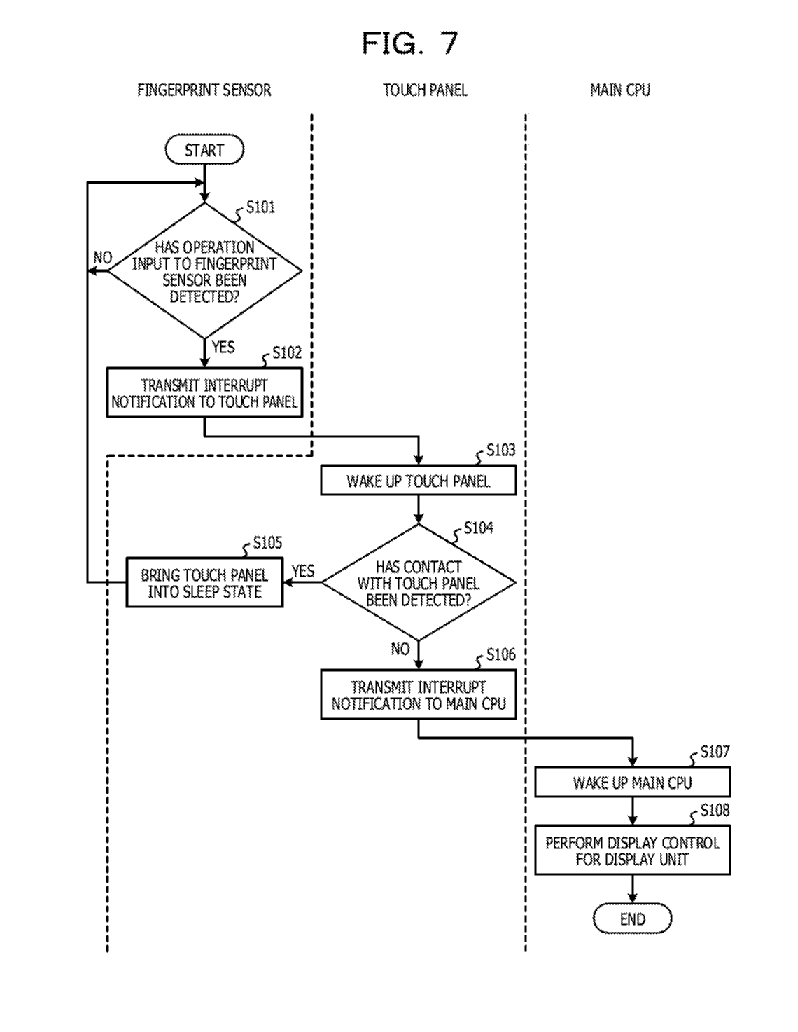

Next, an information processing method performed by a mobile terminal apparatus will be described with reference to FIG. 7.

FIG. 7 is a flowchart illustrating an exemplary information processing method performed by a mobile terminal apparatus according to the first embodiment.

When the main CPU 10 is in a sleep state and the fingerprint sensor 20 is in a detection waiting state, the input detection unit 21 in the fingerprint sensor 20 determines whether an operation input to the fingerprint sensor 20 has been detected (step S101). When it is determined that operation input has not been detected (No in step S101), the input detection unit 21 is kept in the detection waiting state and the processing of step S101 is performed again after a predetermined period has elapsed. On the other hand, it is determined that an operation input has been detected (Yes in step S101), the determination unit 22 transmits an instruction signal used for the wake-up of the main CPU 10 to the activation control unit 23. Upon receiving the instruction signal, the activation control unit 23 transmits an interrupt notification to the determination unit 32 in the touch panel 30 so as to activate the touch panel 30 (step S102).

Upon receiving the interrupt notification from the activation control unit 23, the determination unit 32 in the touch panel 30 starts to supply power to the control IC 36 in the touch panel 30 and wakes up the touch panel 30 (step S103). The determination unit 32 determines whether the contact detection unit 31 has detected the contact of a finger or the like with the touch panel 30 within a predetermined period from the receipt of the interrupt notification (step S104). It is desired that the predetermined period be set to one second or less. By limiting a period during which the contact of a finger or the like with the touch panel 30 is monitored, the simultaneous performance of an operation input to the fingerprint sensor 20 and the contact of a finger or the like with the touch panel 30 can be detected. The probability of detecting an unintended operation input to the fingerprint sensor 20 can therefore be increased.

When the contact detection unit 31 determines that the contact of a finger or the like with the touch panel 30 has been detected (Yes in step S104), the determination unit 32 determines that the operation input to the fingerprint sensor 20 has been unintentionally performed. The determination unit 32 stops the supply of power to the control IC 36 in the touch panel 30 and brings the touch panel 30 into the sleep state again (step S105). On the other hand, when it is determined that the contact of a finger or the like with the touch panel 30 has not been detected (No in step S104), it is determined that the operation input to the fingerprint sensor 20 has been intentionally performed. The activation control unit 33 transmits an interrupt notification to the main CPU 10 so as to wake up the main CPU 10 (step S106).

Upon receiving the interrupt notification from the activation control unit 33 in the sleep state, the main CPU 10 starts to supply power thereto and wakes up (step S107).

After the main CPU 10 has waked up, the main CPU 10 performs display control for the display unit 40 (step S108). More specifically, when a user uses a lock function released by fingerprint authentication, the main CPU 10 displays a screen for fingerprint authentication on the display unit 40. When the user is successfully authenticated in the fingerprint authentication, the main CPU 10 releases the lock function and causes the display unit 40 to display a screen allowing an operation input. As a result, the user can use the mobile terminal apparatus 100. On the other hand, when the user is unsuccessfully authenticated in the fingerprint authentication, the main CPU 10 causes the display unit 40 to display a screen informing the user that the locked state will be kept. When the user does not use the lock function released by fingerprint authentication, the main CPU 10 causes the display unit 40 to display a screen allowing an operation input. As a result, the user can use the mobile terminal apparatus 100.

Thus, a mobile terminal apparatus can perform information processing.

In general, when a user intentionally performs an operation input to a fingerprint sensor, the user usually does not touch a touch panel. That is, when the contact with a touch panel has been detected at the time of detection of an operation input to a fingerprint sensor, it can be determined that the operation input has been probably unintentionally performed. According to the first embodiment, in a case where the fingerprint sensor 20 detects an operation input when the screen of the mobile terminal apparatus 100 is in a non-display state, the presence of absence of detection of the contact with the touch panel 30 is detected. In a case where it is determined that the contact with the touch panel 30 has not been detected, the non-display state of the screen is released and an image is displayed on the screen. With this method, in a case where it is determined that a user has probably unintentionally performed an operation input by detecting the contact with the touch panel 30, a mobile terminal apparatus is not waked up. It is therefore possible to reduce the unnecessary wake-up of the mobile terminal apparatus and achieve a reduction in power consumption.

According to the first embodiment, in a case where the fingerprint sensor 20 detects an operation input, the touch panel 30 is waked up. In a case where it is determined that the contact with the touch panel 30 has not been detected, the main CPU 10 is waked up and the screen of the mobile terminal apparatus 100 is turned on. That is, the wake-up of the mobile terminal apparatus 100 is performed in three steps. According to this method, it is possible to minimize power consumed for processing according to an embodiment of the present disclosure.

[Modification]

Next, the modification of the first embodiment will be described. When a user unintentionally touches the fingerprint sensor 20 and the touch panel 30 at the same time, the contact portion of the touch panel 30 is probably large as illustrated in, for example, FIG. 4. In this modification, in a case where the contact detection unit 31 detects the contact with the touch screen 34 of the touch panel 30, it is determined whether to wake up the main CPU 10 based on a contact portion on the touch screen 34.

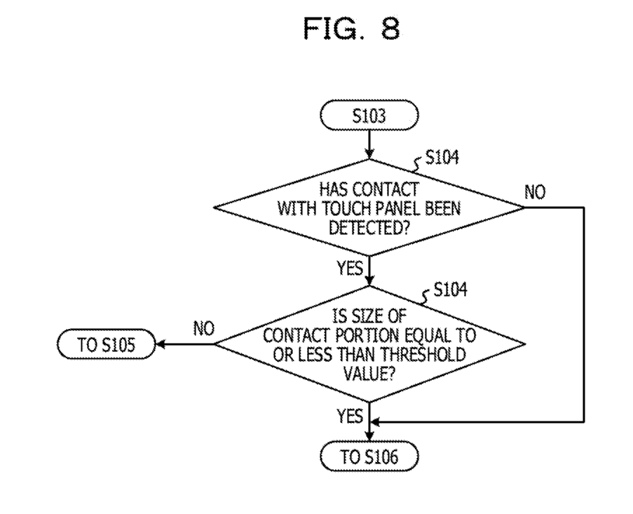

FIG. 8 is a flowchart illustrating a modification of an information processing method performed by a mobile terminal apparatus according to the first embodiment.

The process from step S101 to step S104 is the same as that illustrated in FIG. 7, and the description thereof will be therefore omitted. It is determined in step S104 that the contact detection unit 31 has not detected the contact with the touch screen 34 within a predetermined period from the receipt of the interruption notification (No in step S104), the determination unit 32 determines that an operation input to the fingerprint sensor 20 has been intentionally performed and the process proceeds to step S106 illustrated in FIG. 7. The process subsequent to step S106 is performed, so that the screen of the display device in the mobile terminal apparatus 100 is turned on.

On the other hand, it is determined that the contact detection unit 31 has detected the contact with the touch screen 34 within a predetermined period from the receipt of the interrupt notification (Yes in step S104), the determination unit 32 determines whether a contact portion is equal to or less than a threshold value (step S104a). More specifically, the number of coordinates at detected contact positions on the touch screen 34 is defined as the size of a contact portion. By comparing the number of coordinates received from the contact detection unit 31 with a predetermined threshold value, the above-described determination can be performed. Alternatively, for example, the area of a contact region obtained by connecting coordinates at detected contact positions is calculated and the calculated area is defined as the size of a contact portion. By comparing the calculated area with a predetermined threshold value, the above-described determination can be performed.

When it is determined in step S104a that the size of the contact portion is greater than the threshold value (No in step S104a), it is determined that the operation input to the fingerprint sensor 20 has been unintentionally performed and the process proceeds to step S105. In step S105, the determination unit 32 brings the touch panel 30 into the sleep state again. The process returns to step S101.

On the other hand, when it is determined that the size of the contact portion is equal to or less than the threshold value (Yes in step S104a), the determination unit 32 determines that the operation input to the fingerprint sensor 20 has been intentionally performed and the process proceeds to step S106. In step S106, the activation control unit 33 causes the main CPU 10 to wake up. The process subsequent to step S107 is the same as that illustrated in FIG. 7, and the description thereof will be omitted.

Thus, a mobile terminal apparatus can perform information processing.

According to this modification, in a case where the size of a contact portion is equal to or less than a threshold value, the main CPU is not waked up. Accordingly, even in a case where a user unintentionally touches a touch panel while performing an operation input to a fingerprint sensor so as to wake up a mobile terminal apparatus, the mobile terminal apparatus can be waked up.

### Second Embodiment

Next, the second embodiment of the present disclosure will be described. In the first embodiment, each of the fingerprint sensor 20 and the touch panel 30 performs a part of processing according to an embodiment of the present disclosure. In the second embodiment, processing performed by the touch panel 30 in the first embodiment is performed by the main CPU 10.

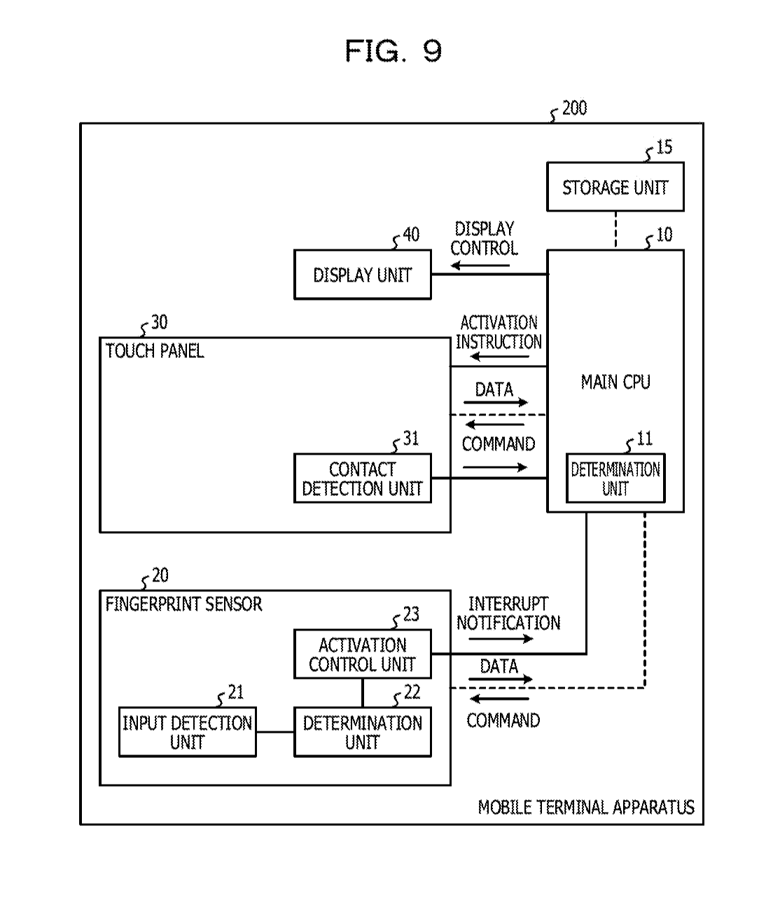

FIG. 9 is an exemplary functional block diagram of a mobile terminal apparatus according to the second embodiment. Referring to FIG. 9, the same reference numerals are used to identify functional blocks already described with reference to FIG. 1, and the description thereof will be therefore omitted. As illustrated in FIG. 9, in a mobile terminal apparatus 200 according to the second embodiment, the main CPU 10 includes a determination unit 11 and the touch panel 30 includes the contact detection unit 31. The configuration of the fingerprint sensor 20 is nearly the same as that of the fingerprint sensor 20 illustrated in FIG. 1 except that the activation control unit 23 in the fingerprint sensor 20 is coupled not to the determination unit 32 in the touch panel 30 but to the main CPU 10. Like in FIG. 1, in FIG. 9, for convenience of reference, the connection between blocks according to the second embodiment is represented by a solid line and the other connections are represented by broken lines.

The hardware configuration of a mobile terminal apparatus according to the second embodiment is nearly the same as that of a mobile terminal apparatus according to the first embodiment illustrated in FIG. 2, and the description thereof will be therefore omitted.

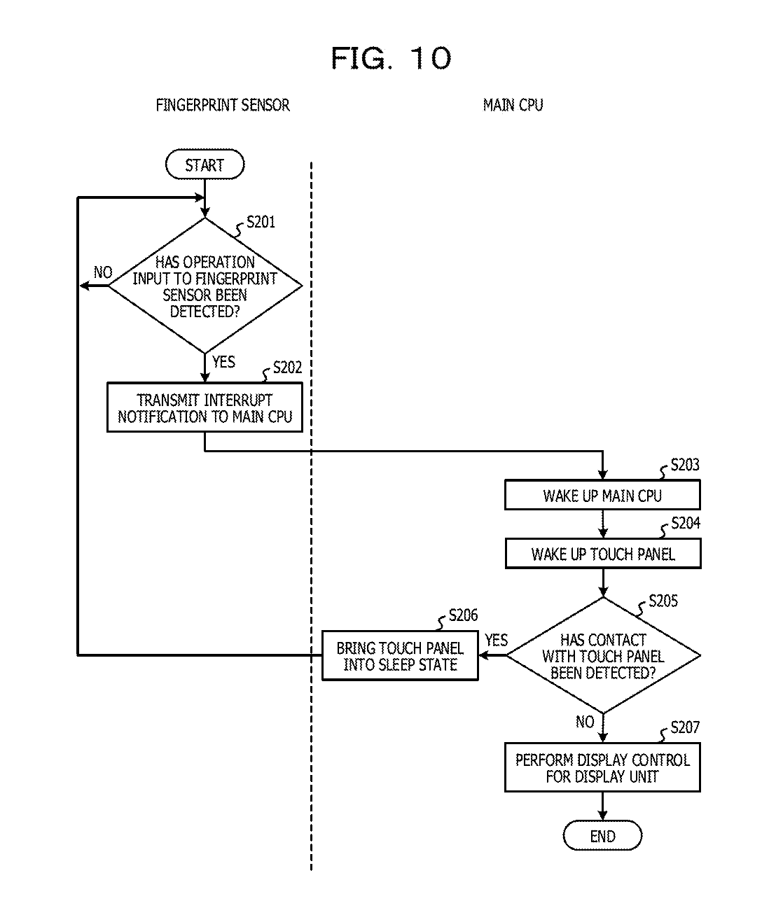

FIG. 10 is a flowchart illustrating an exemplary information processing method performed by a mobile terminal apparatus according to the second embodiment.

When the main CPU 10 is in a sleep state and the fingerprint sensor 20 is in a detection waiting state, the determination unit 22 in the fingerprint sensor 20 determines whether the input detection unit 21 has detected an operation input to the fingerprint sensor 20 (step S201). When it is determined that the input detection unit 21 has not detected an operation input (No in step S201), the determination unit 22 is kept in the detection waiting state and performs the processing of step S201 again after a predetermined period has elapsed. On the other hand, it is determined that the input detection unit 21 has detected an operation input (Yes in step S201), the determination unit 22 transmits an instruction signal used for the wake-up of the main CPU 10 to the activation control unit 23. Upon receiving the instruction signal, the activation control unit 23 transmits an interrupt notification to the main CPU 10 so as to cause the main CPU 10 to perform wake-up (step S202).

Upon receiving the interrupt notification from the activation control unit 23, the main CPU 10 starts to supply power to a circuit therein and wakes up (step S203). Subsequently, the main CPU 10 starts to supply power to the control IC 36 in the touch panel 30 so as to cause the touch panel 30 to perform wake-up (step S204).

The determination unit 11 in the main CPU 10 determines whether the contact detection unit 31 in the touch panel 30 has detected the contact of a finger or the like with the touch screen 34 within a predetermined period from the receipt of the interrupt notification (step S205). When it is determined that the contact detection unit 31 has detected the contact of a finger or the like with the touch screen 34 (Yes in step S205), the determination unit 11 determines that the operation input to the fingerprint sensor 20 has been unintentionally performed. The determination unit 11 stops the supply of power to the control IC 36 in the touch panel 30 and brings the touch panel 30 into the sleep state again (step S206). Subsequently, the process returns to step S201 and the processing of step S201 is performed again.

On the other hand, when it is determined that the contact detection unit 31 has not detected the contact of a finger or the like with the touch screen 34 (No in step S205), the determination unit 32 determines that the operation input to the fingerprint sensor 20 has been intentionally performed. The main CPU 10 performs display control for the display unit 40 and changes the screen of the display unit 40 from the OFF state to the ON state (step S207). This allows a user to perform an operation input to the touch panel 30 and use the mobile terminal apparatus 200.

Thus, the mobile terminal apparatus 200 can perform information processing.

According to the second embodiment, in a case where it is determined that a user has probably unintentionally performed an operation input, the screen of the mobile terminal apparatus 200 is not turned on. It is therefore possible to reduce the unnecessary activation of the screen of the mobile terminal apparatus 200 and achieve a reduction in power consumption.

According to the second embodiment, the processing of determining the contact with the touch panel 30 is performed not by the touch panel 30 but by the main CPU 10. Since it is unnecessary to store a program for the processing of determining the contact with the touch panel 30 in the control IC 36, the control IC 36 can have a simpler configuration than that according to the first embodiment.

### Third Embodiment

Next, the third embodiment will be described. In the third embodiment, a sub CPU 70 independent of the main CPU 10 performs processing according to an embodiment of the present disclosure on behalf of the fingerprint sensor 20 and the touch panel 30.

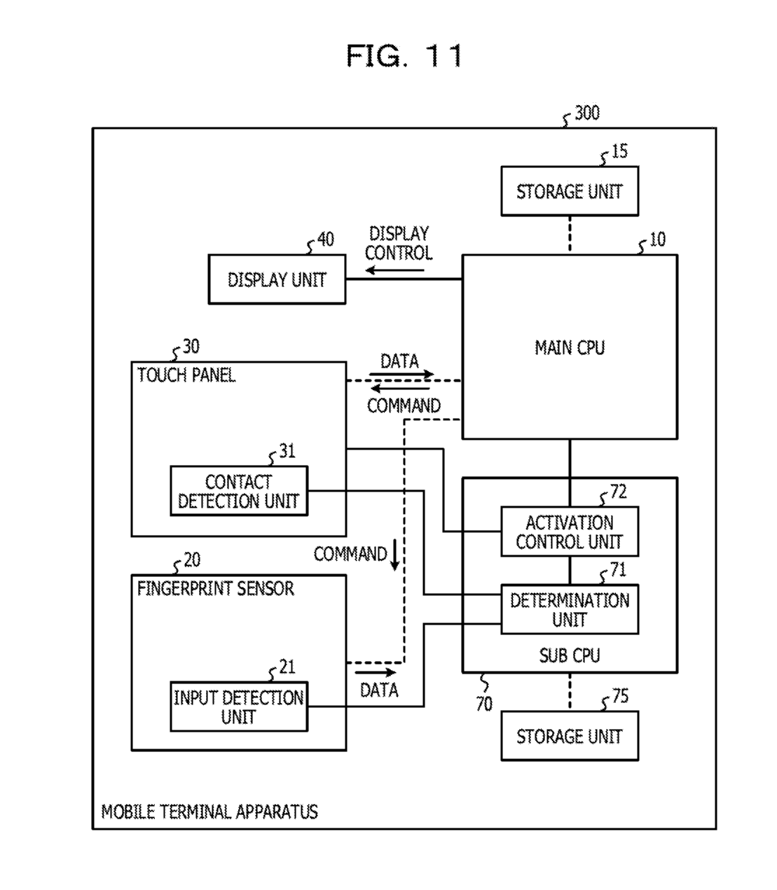

FIG. 11 is an exemplary functional block diagram of a mobile terminal apparatus according to the third embodiment. Referring to FIG. 11, the same reference numerals are used to identify functional blocks already described with reference to FIG. 1, and the description thereof will be therefore omitted. As illustrated in FIG. 11, a mobile terminal apparatus 300 includes the main CPU 10, the storage unit 15, the fingerprint sensor 20, the touch panel 30, the display unit 40, the sub CPU 70, and a storage unit 75. The sub CPU 70 is coupled to the main CPU 10, the fingerprint sensor 20, the touch panel 30, and the storage unit 75 so that they can communicate with each other. Like in FIGS. 1 and 9, in FIG. 11, for convenience of reference, the connection between blocks according to an embodiment of the present disclosure is represented by a solid line and the other connections are represented by broken lines.

In the third embodiment, the fingerprint sensor 20 includes the input detection unit 21 and the touch panel 30 includes the contact detection unit 31. The functions of the main CPU 10 and the storage unit 15 are the same as those of the main CPU 10 and the storage unit 15 illustrated in FIG. 1, and the description thereof will be therefore omitted.

The sub CPU 70 includes a determination unit 71 for performing determination processing and an activation control unit 72 for controlling the activation of the main CPU 10 or the touch panel 30. More specifically, the activation control unit 72 wakes up the main CPU 10 or the touch panel 30, keeps the main CPU 10 or the touch panel 30 in a sleep state, or brings the main CPU 10 or the touch panel 30 into the sleep state.

The storage unit 75 is a piece of hardware for storing data used for processing performed by the sub CPU 70 and a program. Like the storage unit 15, the storage unit 75 may be achieved using a plurality of storage devices in accordance with an application or a desired storage capacity.

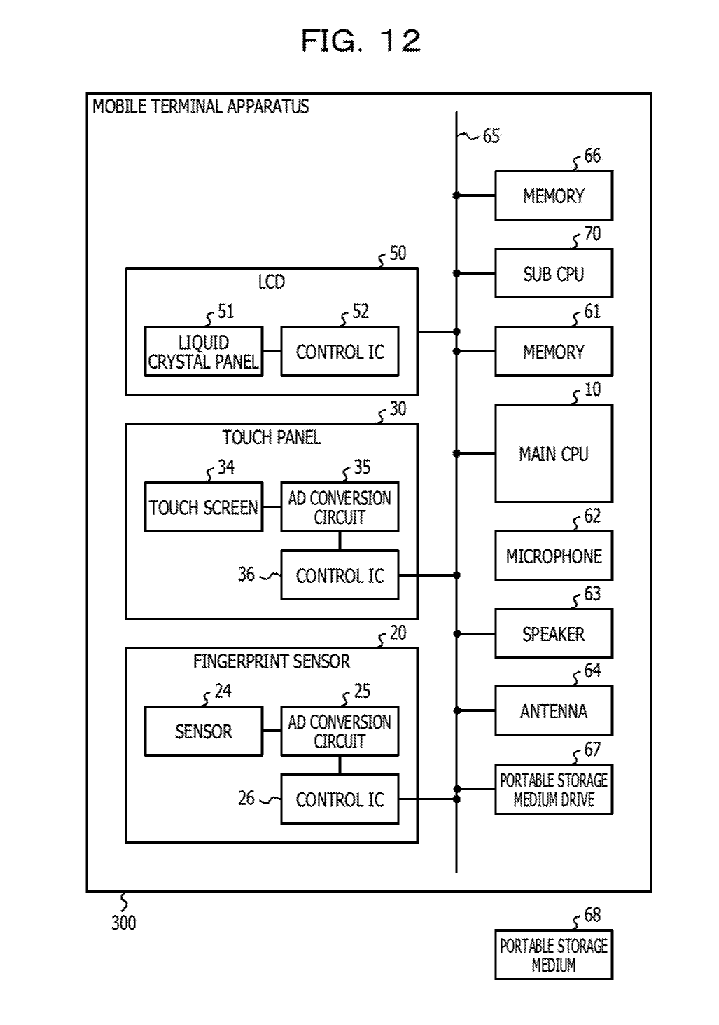

FIG. 12 is a diagram illustrating an exemplary hardware configuration of a mobile terminal apparatus according to the third embodiment. The same reference numerals are used to identify parts already described with reference to FIG. 1, and the description thereof will be therefore omitted. As illustrated in FIG. 12, the mobile terminal apparatus 300 includes the sub CPU 70, a memory 66, and a portable storage medium drive 67 which are coupled to the bus 65.

The sub CPU 70 is a processor for executing a processing program according to the third embodiment. The processing program can be stored in the memory 66. The memory 66 is equivalent to an example of the storage unit 75 illustrated in FIG. 11. Like the memory 61, the memory 66 is, for example, a RAM, a flash memory, or a ROM, and may be the combination of some of them.

In the mobile terminal apparatus 300, the portable storage medium drive 67 can load a program read from a portable storage medium 68 into a RAM that is an example of the memory 66 so as to cause the sub CPU 70 to execute the program.

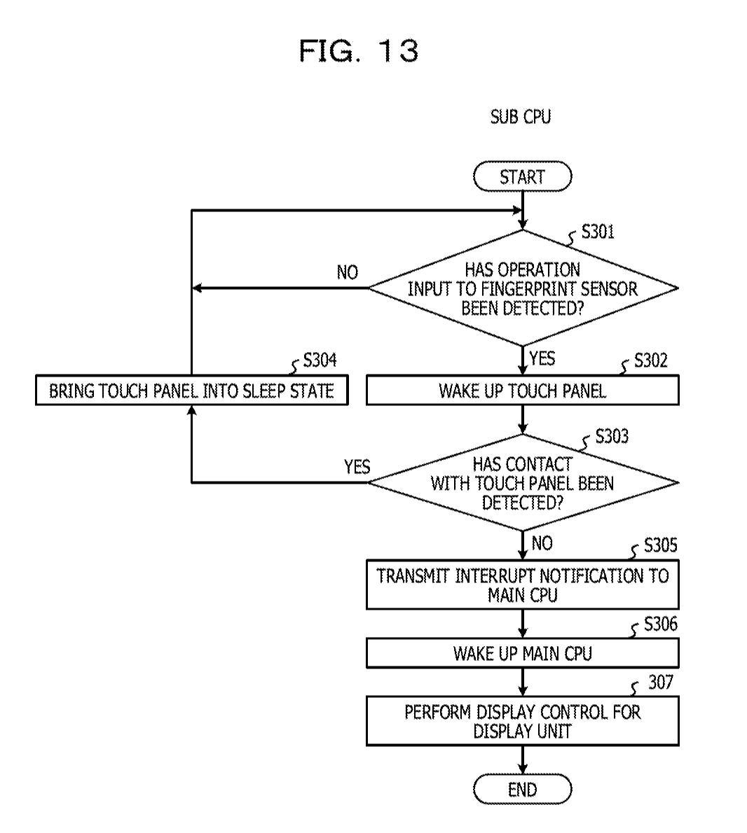

FIG. 13 is a flowchart illustrating an exemplary information processing method performed by a mobile terminal apparatus according to the third embodiment.

When the main CPU 10 is in a sleep state and the fingerprint sensor 20 is in a detection waiting state, the determination unit 71 in the sub CPU 70 determines whether the input detection unit 21 in the fingerprint sensor 20 has detected an operation input to the fingerprint sensor 20 (step S301). When it is determined that the input detection unit 21 has not detected an operation input (No in step S301), the activation control unit 72 in the sub CPU 70 keeps the input detection unit 21 in the detection waiting state. After a predetermined period has elapsed, the determination unit 71 performs the processing of step S301 again.

On the other hand, when it is determined that the input detection unit 21 has detected an operation input (Yes in step S301), the activation control unit 72 supplies a current to the control IC 36 in the touch panel 30 so as to cause the touch panel 30 to wake up (step S302). Subsequently, the determination unit 71 determines whether the contact detection unit 31 has detected the contact of a finger or the like with the touch screen 34 within a predetermined period from the receipt of the interrupt notification (step S303).

When it is determined that the contact detection unit 31 has detected the contact with the touch screen 34 (Yes in step S303), the determination unit 71 determines that the operation input to the fingerprint sensor 20 has been unintentionally performed. The activation control unit 72 stops the supply of power to the control IC 36 in the touch panel 30 and brings the touch panel 30 into the sleep state again (step S304). The process returns to step S301.

On the other hand, when it is determined that the contact detection unit 31 has not detected the contact with the touch screen 34 (No in step S303), the determination unit 71 determines that the operation input to the fingerprint sensor 20 has been intentionally performed. The activation control unit 72 transmits an interrupt notification to the main CPU 10 so as to cause the main CPU 10 to wake up (step S305).

When the main CPU 10 receives the interrupt notification from the activation control unit 72 in the sleep state, the activation control unit 72 starts to supply power to the main CPU 10 so as to wake up the main CPU 10 (step S306). Furthermore, the activation control unit 72 performs display control for the display unit 40 and changes the screen of the display unit 40 from the OFF state to the ON state (step S307). As a result, the mobile terminal apparatus 300 is changed from the sleep state to a state allowing a user to use the mobile terminal apparatus 300.

Thus, a mobile terminal apparatus can perform information processing.

According to the third embodiment, the sub CPU 70 performs a process according to an embodiment of the present disclosure. Since it is unnecessary to store a processing program in the control ICs 26 and 36, the control ICs 26 and 36 can have simpler configurations than those according to the first and second embodiments.

Although the embodiments of the present disclosure have been described in detail above, the present disclosure is not limited to these embodiments. Various modifications and changes can be made to these embodiments. For example, in the embodiments, a mobile terminal apparatus including a fingerprint sensor having a function of causing the mobile terminal apparatus to wake up has been described. Instead of the fingerprint sensor, a mobile terminal apparatus may include an electrostatic sensor having a function of causing the mobile terminal apparatus to wake up when detecting the contact of a hand or the like. In this case, the electrostatic sensor functions as a sensor according to an embodiment of the present disclosure. That is, in a case where the electrostatic sensor detects an operation input by detecting the contact therewith when the mobile terminal apparatus is in a sleep state, the presence or absence of the detection of a contact with a touch panel is determined. In a case where it is determined that the contact with the touch panel has been detected, the wake-up of the mobile terminal apparatus is performed. With this method, it is possible to reduce the unnecessary wake-up of the mobile terminal apparatus and achieve a reduction in power consumption.

A computer program for causing a computer to function as the above-described mobile terminal apparatus and to perform the above-described information processing method and a non-transitory computer readable recording medium recording the computer program are included in the scope of the present disclosure. The non-transitory computer readable recording medium is, for example, a memory card such as an SD memory card. The computer program does not necessarily have to be stored in the recording medium, and may be transmitted via a telecommunication line, a wireless or wired communication line, or a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a sensor;
a touch panel; and
a processor coupled to the sensor and the touch panel and is configured to control the information processing apparatus,
wherein the sensor is configured to transmit an interrupt notification to the touch panel so as to wake up the touch panel when detecting an operation performed upon the sensor, and
wherein the touch panel is configured to:
determine whether a contact with the touch panel has been detected when being waked up, and
transmit an interrupt notification to the processor so as to wake up the processor when it is determined that a contact with the touch panel has not been detected.

2. The information processing apparatus according to claim 1,
wherein the touch panel is configured to be brought into a sleep state when it is determined that a contact with the touch panel has been detected.

3. The information processing apparatus according to claim 1, further comprising
a display that is disposed to overlap the touch panel,
wherein the processor is configured to transmit a display control signal to the display so as to bring the display into a display state, when receiving the interrupt notification used for wake-up of the processor.

4. The information processing apparatus according to claim 1, wherein the sensor is a fingerprint sensor.

5. The information processing apparatus according to claim 4,
wherein the sensor is configured to determine whether a contact with the touch panel has been detected, when detecting a contact with the sensor.

6. The information processing apparatus according to claim 4,
wherein the sensor is configured to determine whether a contact with the touch panel has been detected, when detecting an operation of pressing the sensor.

7. The information processing apparatus according to claim 1,
wherein the sensor is an electrostatic sensor configured to determine whether a contact with the touch panel has been detected, when detecting a contact with the electrostatic sensor.

8. The information processing apparatus according to claim 1,
wherein the sensor is configured to determine that the contact with the touch panel has not been detected, when a contact with the touch panel is not detected within a predetermined period from detection of an operation performed upon the sensor.

9. The information processing apparatus according to claim 1,
wherein the sensor is configured to determine that the contact with the touch panel has not been detected, when a portion of a contact with the touch panel detected within a predetermined period from detection of an operation performed upon the sensor is equal to or less than a threshold value.

10. An information processing apparatus, comprising:
a sensor;
a display;
a touch panel that is disposed to overlap the display; and
a processor configured to control the information processing apparatus,
wherein the sensor is configured to
transmit an interrupt notification to the processor so as to wake up the processor when detecting an operation performed upon the sensor, and
wherein the processor is configured to:
determine whether a contact with the touch panel has been detected when being waked up, and
transmit a display control signal to the display so as to bring the display into a display state when it is determined that a contact with the touch panel has not been detected.

11. An information processing method executed by a touch panel included in an information processing apparatus, the information processing method comprising:
determining whether a contact with the touch panel has been detected when detecting an operation performed upon a sensor; and
transmitting a wake-up signal to a processor for controlling the information processing apparatus so as to wake up the information processing apparatus when it is determined that a contact with the touch panel has not been detected.
